(19) United States
(12) Patent Application Publication
(10) Pub. No.: US 2009/0100013 A1
(43) Pub. Date: Apr. 16, 2009

(54) METHOD OR APPARATUS OF DATA PROCESSING TO COMPILE A DIGITAL DATA MEDIA PRESENTATION FOR TRANSFERRING BETWEEN ONE OR MORE COMPUTERS

(76) Inventors: GENE S. FEIN, Lenox, MA (US); Edward Merritt, Lenox, MA (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 11/870,032

(22) Filed: Oct. 10, 2007

(51) Int. Cl. G06F 7/06; G06F 17/30; G06F 3/14

(52) U.S. Cl. 707/3; 715/201; 707/E17.014

(57) ABSTRACT

As media on the Internet grows, existing systems do not leverage the value of using online digital data media, such as a movie clip or song, for creating media presentations. In contrast, a system of the present invention compiles a media presentation for transferring data between one or more computers by requesting one or more digital data media, such as a video clip. After requesting the one or more digital data media, the system, if applicable, obtains authorization, such as a license, to use the one or more digital data media. Further, the system allows a user to edit the requested digital data media and any existing digital data media. After editing the digital data media, the system compiles the media to make a media presentation. In this way, the present invention leverages the use of digital data media to create a media presentation by employing the data or instructions before or after transferring.

### BACKGROUND OF THE INVENTION

Today, studio production of digital audiovisual recordings create media presentations by storing and editing media from a database or other storage system. The media is typically found in a linear or analog editing system, and the media is individually and collectively and edited. These media recordings are very time consuming and can cost anywhere from hundreds of dollars to hundreds of millions of dollars per project.

In recent years, the audiovisual recording industry has gone through a transformation as digital technology data has helped reduce the cost of professional recording quality production. As a result, millions of home studios across the world, mostly running high end capture, editing, and mixing software can produce the same end product as the large recording studios. Although the use of digital technology is reducing cost, both large and home studios have not yet embraced the use of media on the Internet. As media on the Internet grows, existing systems do not leverage the value of using online digital data media for creating media presentations. Accordingly, there is a need for a such a tool, program, or system.

### SUMMARY OF THE INVENTION

In a method or corresponding apparatus, a system compiles a digital data media presentation for transferring between one or more computers. In an embodiment, the system transfers data or instruction information between a plurality of computers, where the computers employ the data or instructions before or after transferring and the employing affects said transfer of data or instruction information. In operation, the system compiles a media presentation by requesting one or more digital data media. In embodiments, a user can perform a search before requesting the one or more digital data media. After requesting the one or more digital data media, the system, if applicable, obtains authorization, such as a license, to use the one or more digital data media. After obtaining authorization, the system allows a user to edit the requested digital data media and any existing digital data media in such a manner as to make a media presentation and compiles the system.

In an embodiment, the one or more digital data media can be one of the following: film, movie, report, television, webisode, commercial, beta, or digital data. Further, a system may display the one or more digital data media to a user.

In yet another embodiment, the system requests one or more digital data media and obtains legal authorization for using the one or more digital data media. This legal authorization may include a license agreement or compulsory license.

In still yet another embodiment, the system edits the digital data media by using a digital tool to modify the one or more media. Editing of the digital data media may include integrating multiple medias in such a way as to make a single media presentation. The system then compiles the edits into a useable product for an end user, such as a DVD, online sharing program, or other suitable presentation.

In yet still another embodiment of the present invention, a system models audiovisual media in a graphically dimensional representation, which can be graphically adjusted with editing tools. Further, the system allows a user to search a database or network node to locate a scene of a film, a report, or other audiovisual project. Once the user selects a scene, a media compiler composites the users selection into the users media presentation. As the user selects the media, the media compiler ensures that rights and clearances (e.g., a license) for redistribution of the users finished media presentation is available. Moreover, music for different scenes may also be selected and integrated into the media presentation in this manner. Editing tools for the system allow a user to edit, cut, paste the media to graphics, titles, stock images/footage, or the like. The media presentation, which may be generated from many different sources, formats, and styles, can be compiled using filters and effects of the media compiler's editing tool. In this way, embodiments of the present invention creates a media presentation using media from multiple sources with appropriate legal authorization.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 shows a network diagram including a media compiler to create a media presentation according to an example embodiment of the present invention;

FIG. 2 is a network diagram including the media compiler, which provides editing capabilities of one or more selected media according to an example embodiment of the present invention;

FIG. 3 shows a flow chart for producing a media presentation in accordance with an example embodiment of the present invention;

FIG. 4 is a flow diagram showing a process for compiling one or more media to create a media presentation according to an example embodiment of the present invention;

FIG. 5 is a flow diagram of a user obtaining media and entering into a license agreement for one or more media in accordance with an example embodiment of the present invention;

FIG. 6 is a flow diagram of a user accessing a licensing interface for a website according to an example embodiment of the present invention; and

FIG. 7 is a flow diagram of a process for an overall process of executing and enforcing a licensing agreement according to an example embodiment of the present invention.

### DETAILED DESCRIPTION OF THE INVENTION

A description of example embodiments of the invention follows.

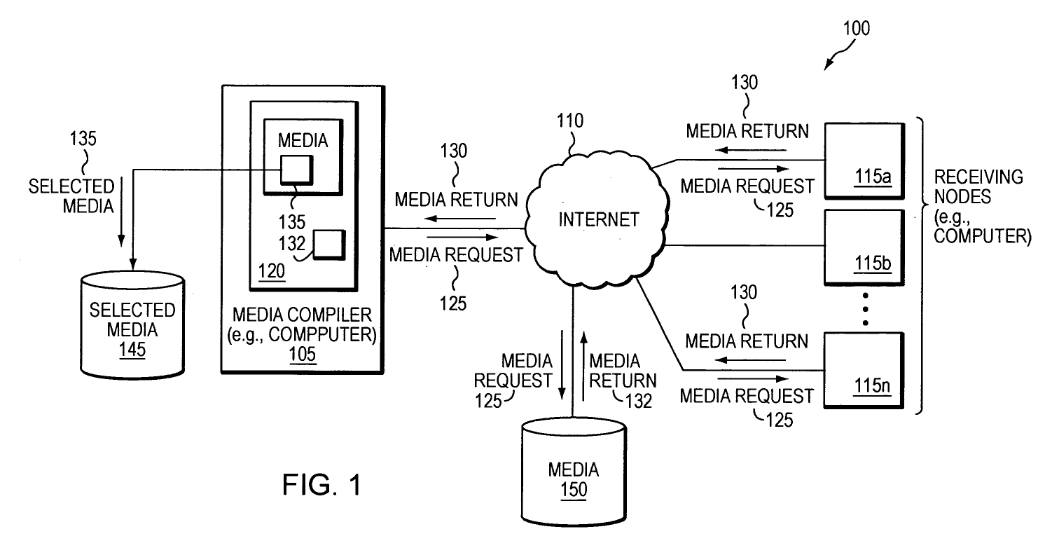

FIG. 1 shows a network diagram 100 including a media compiler 105 to create a media presentation for transferring data between computers (e.g., media compiler 105 and receiving node 115a). Specifically, FIG. 1 shows a media compiler 105 (e.g., a network node) with a display 120. The display 120 provides a user a selection screen with a description of one or more digital data media 135 (e.g., film, movie, report, television, webisode, commercial, beta, or digital data) for download. A user may configure the media compiler 105 to display descriptions for digital data media 135 that meets a search criteria otherwise the digital data media 135 may be selected based on a pre-determined search.

In use, the display 120 allows a user to view the description and select the digital data media 135 for download. For example, the user views a song clip (e.g., digital data media 135) on the display 120 and selects the song (e.g., digital data media 135) for download by clicking on button 132, which in turn issues a media request 125 to obtain the song. Upon issuing the media request 125, the media compiler 105 transmits over a network, such as Internet 110, to one or more receiving nodes (e.g., one or more other network nodes 115a-n or a database 150) to download the song. It is useful to note that the receiving nodes may include the following media: video, graphics, audio, a segment of a video, a compilation, or other type of audiovisual material suitable for use in a presentation.

After sending the media request 125, the network nodes 115a-n or database 150 sends a media return 130, via the Internet 100, to the media compiler 105. The media compiler 105, displays the media to the user in the display 120. A user may select the digital data media 135, which results in the media compiler 105 storing the selected digital data media 135 to a database 145 for storage and subsequent use. In a convenient embodiment, a user is a filmmaker, television producer, or audiovisual compositions creator, which sends a media request with search criteria (e.g., a description of the audiovisual material). An example of such search criteria may be a description, such as “hospital birth video” or “hospital birth video with a female doctor and American parents from 1960.” Embodiments of the present invention may use any number of traditional keyword searching or other suitable engine/tool. The teachings of traditional searching is described in U.S. Pat. No. 6,513,035 which is hereby incorporated by referenced. As a result of the search, the user obtains one or more media matching those keywords and selects one or more media to download.

For further convenience, the media compiler 105 allows searching at any website or database, which includes audio, visual, or audiovisual materials. The media compiler 105 also can use keywords and audiovisual identification systems to locate the best results for each search request made by a user. That is, embodiments create a “siftware” experience for the user. A “siftware” experience allows a user to sift through descriptions of audio and video clips and save the portions or all of the same. In this way, the media compiler 105 allows the user to create a media story line by adding digital data media 135, which may include an image, audio, and/or video from one or more sources (e.g., a computer or database) to create a media presentation.

However, one issue that arises when obtaining audio, visual, or audiovisual material from the Internet is the material may require legal permission (e.g., clearance for the content/media) from an owner. For example, if a user is planning on selecting a song found in database 150, the user may need to obtain a permission or a license from the owner to use the song. In an embodiment of the present invention, the media compiler 105 provides a copyright clearance request to the owner of the song, image, or video (e.g., selected digital data media 135). By sending the clearance request, the user describes the use, term, territory, and fee suggested to use the selected digital data media 135. If these terms are agreeable to the owner of the song, the media compiler 105 forms a licensing agreement, which can be executed by the user and owner of the song. It should be understood that the media compiler 105 can issue the clearance request for multiple media in one or multiple locations.

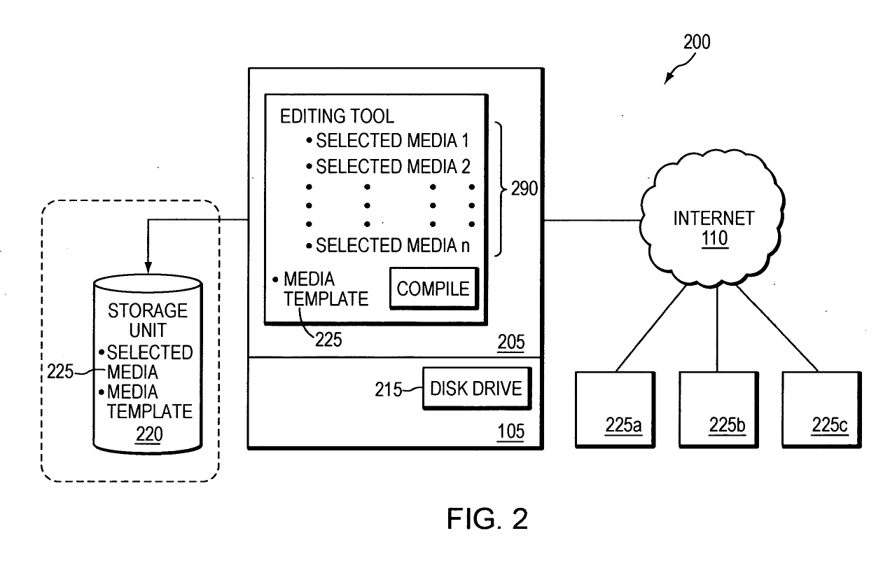

FIG. 2 is a network diagram 200 including the media compiler 105 of FIG. 1, which provides editing capabilities, using a digital tool such as an editor, for one or more selected media 210. In particular, an example embodiment provides a media compiler 105 having a disc drive 215 (e.g., CD-ROM or DVD) and a display 205, which connects to network nodes 225a-c, communicating over the Internet 110, and a storage unit 220. In use, a user begins a search for media in a similar manner as is described in FIG. 1. For example, a user issues a keyword search in a network node 225a to locate a scene by scene account of a film, report, or other audiovisual project (e.g., a media). After finding a suitable media, the user selects the media, which is presented as selected media 210 in the display 205 and optionally stored in the storage unit 220 for later use. It should be understood that a user is not limited to the number of media that may be selected. It should be further understood that a user may also use existing media for creating a media presentation (e.g., embodiments of the present invention do not require searching for media).

In a convenient embodiment, a user obtains selected media 210 and the media compiler 205 places the users selection in a film. For example, the media compiler 105 stores the music for multiple scenes, graphics, or titles based on the user search in the media compiler 105. After storing the selected media 210, the media compiler 105 allows a user to integrate the selected media 210 into a composition/media presentation. After storing the selected media 210, the media compiler 105 allows the user to edit the selected media 210 clips to create a media presentation. It is useful to note that in addition to selecting audiovisual material, a user may also select graphics, still images, and music to create transitions and/or graphic packages that may augment the selected media 210 or any existing media.

Referring now to the creation of the media presentation, the user may integrate multiple selected media 210 into a single video sequence or a single selected media 210 into multiple video sequences. That is, the selected media 210, which the user obtains from different sources, formats, and styles, can be unified by using the media compiler 105. Moreover, the media compiler 105 may create a graphical digital audiovisual system, using editing tools in the media compiler 105 that models audiovisual elements as a cohesive graphically dimensional representation. For example, the user can adjust levels of the media, both during the recording process, as well as the mixing and editing process to yield the media in the finished product that the user desires. Some user controls include volume level, high end frequency, low end frequency, bass, treble, delay, and a range of audio and video effects, such as layering or doubling, tripling or quadrupling, colorizing, fading, dissolving, graphic titles and effects a recorded track. It is useful to note that open source digital audiovisual systems and other operating systems can be used to achieve a quality that is substantially equivalent to that of commercial operating systems. It should also be understood that the user has the ability to edit the selected media 210 in any number of ways to create a media presentation. It should be further understood that the editing tools may be located in the media compiler 105 or some other location, such as a stand alone computer. The examples presented above are merely for illustrative purposes and other variations are possible.

In an embodiment of the present invention, the media compiler 105 allows a user to creates one or more scenes of a media presentation by using a scene by scene search of existing media template 225. For example, the media compiler 10$ contains a media template 225, in a storage device 220, which the user searches, finds, and selects. Example templates may include a love story, with the following act templates:
Act 1 template Boy meets Girl in High school.
Act 2 template: Boy Dates Girl in East Coast College.
Act 3 template: Boy/ Young Man moves to California: Find cross country driving scene.
Act 4 template: Man works as a waiter in restaurant in a city.
Act 5 template: Man talks on phone to woman.
Act 6 template: Woman gets on plane & is met at airport by Man, hugging.
Act 7 template: Music introduction for love story.
   A user may select one or more of Act 1-7 templates, allowing the user to customize the media template 225. Further, the user may modify any act, for example, Act 4 template could be changed to the “Man works on a film set.” For each act, the user can access graphics, music, transitions, and other media components that are searchable and selectable using the media compiler 105. Once a user selects the act, the user edits the acts to create the media presentation. After editing, the user may use the media compiler 105 to create or publish a useable product or excerpts (e.g., a media presentation) for an end user in the form of an online video, CD-Rom, CDRW, HDVD, DVD, online sharing program, or the like. Further, the user may export the media presentation to a third party device, other fixed media, or post the media presentation online. Embodiments of the present invention may use any number of traditional publishing methods. The teachings of an example publishing method is described in U.S. Pat. No. 6,625,386 which is hereby incorporated by referenced.

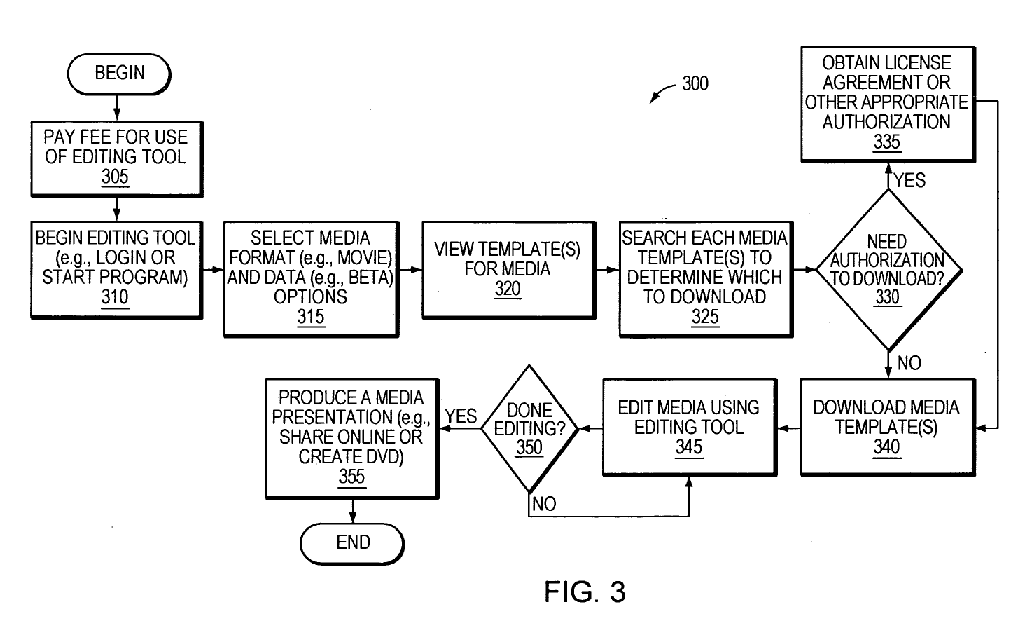

FIG. 3 shows a flow chart 300 for producing a media presentation in accordance with embodiments of the present invention. In step 305, a user pays a fee to use a digital tool, such as the editing tool in the media compiler 105 of FIG. 1. After paying the fee, the user begins using the editing tool by logging in or starting the program in step 310. At step 315, the user selects configuration information, such as the digital data media format (e.g., a film, movie, report, television, webisode, or commercial) and data options (e.g., beta, film, digital, or the like). After selecting the configuration information, the user views available media templates for the media in step 320. Viewing the media templates allows the user to quickly identify what media is available. At step 325, the user searches for each of the desired media/media templates to download. In an embodiment, the editing tool may include existing ‘drag & drop’ media templates for audio, visual & audiovisual programs, such as television programs with/without commercial breaks and films with scene selections credits and transitions.

Once the user identifies which media template to download, the editing tool determines whether authorization is needed to download the media at step 330. Such authorization may include a license agreement, compulsory license, or other legal authorization. If authorization to download is necessary, the media compiler requests a license agreement or other appropriate legal authorization from the media ower at step 335. If no authorization is necessary to download, the media compiler downloads the one or more selected media templates at step 340. Once the one or more media templates are downloaded, the user edits the media templates using the editing tool at step 345. The user completes editing at step 350 and the media compiler produces a media presentation for use or distribution. If the user has not completed the edits, the user may continue to edit the one or more media templates at step 345 until complete. Next, in step 355 the media compiler creates a media presentation in multiple ways, which may include providing: an online shared file, a CD/DVD, media/medium from a storage device, or a downloadable option to users. It should be understood that a user may present a media presentation in many different ways to a user and are not limited by these illustrative examples. It should be further understood that embodiments of the present invention can create media presentations from media templates of any format (e.g., Beta, VHS, or other suitable format).

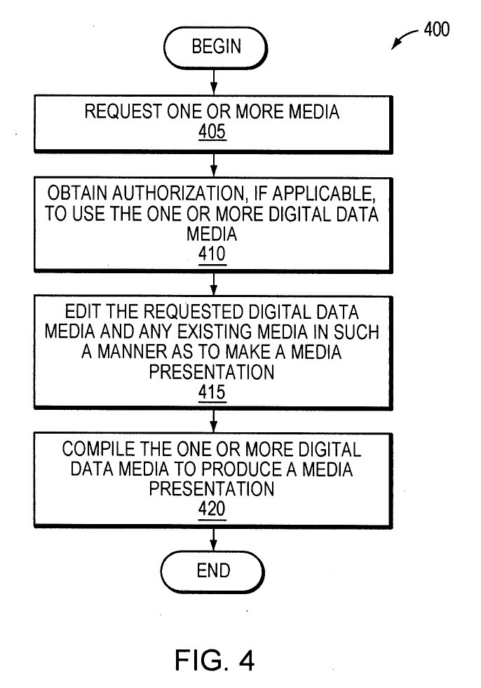

FIG. 4 is a flow diagram showing a process 400 for compiling one or more media to create a media presentation according to an example embodiment of the present invention. After beginning, the process 400 requests one or more digital data media at step 405 for use in a media presentation. At step 410, the process 400, if applicable, obtains authorization to use the one or more digital data media. That is, some media can be downloaded without royalty whereas other media requires permission from the media owner. After ensuring the process 400 has authorized use of the media, the process 400 allows a user to edit the requested media as well as any existing media the user may have in step 415. For example, a user may request one or more digital data media, but also have existing media to be integrated with the requested digital data media. In this example, the user may use an editing tool, such as the editing tool in the media compiler 105 of FIG. 1, to integrate portions of each media to create a media presentation. By using this editing tool, the user can select the type of media format (e.g., video or audio) and media properties (e.g., audio levels) to create a better compilation. For example, the user can assemble the presentation with standardized variable audio and video formats. Once the editing is complete, the media compiler creates a media presentation using the one or more media at step 420. In embodiments of the present invention. the user may use any number of traditional editing tools for assembling the presentations. The teachings of an example editing tool is described in U.S. Pat. No. 6,469,711 which is hereby incorporated by referenced.

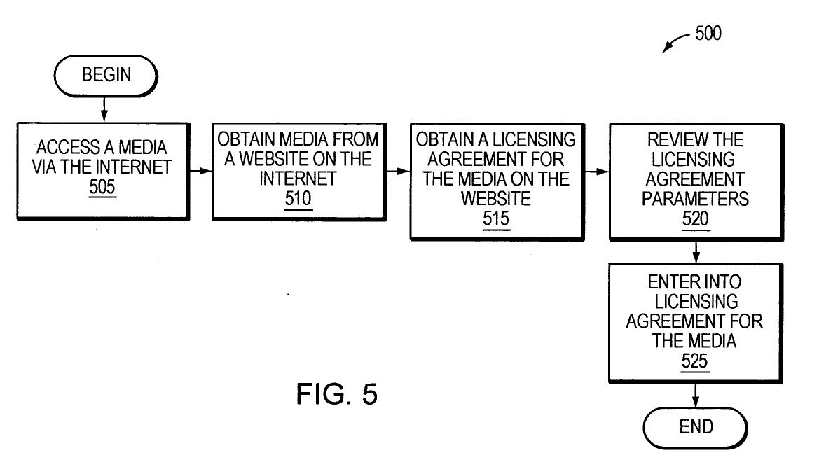

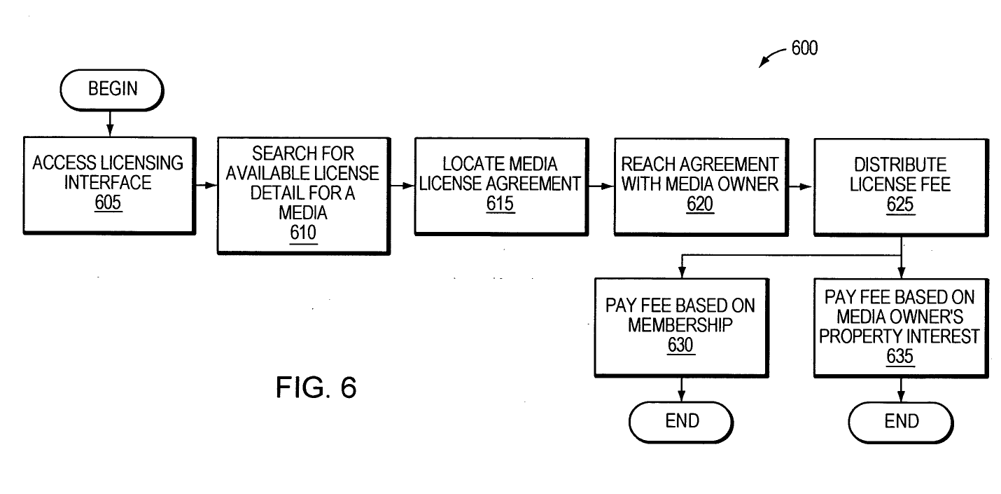

FIG. 5 is a flow diagram 500 of a user obtaining media and entering into a license agreement for one or more media. After beginning, the user accesses a media via the Internet at step 505. At step 510, the user obtains the media from a website over the Internet as described in FIG. 6. Next, the user obtains a licensing agreement for the media, which is provided on the website at step 515. The licensing agreement is a document demonstrating permission to use a particular media. Typically, the licensing agreement may be granted by a party (“licensor”) to another party (“licensee”) as an element of an agreement between those parties. For example, a licensor may grant a permission to a licensee to copy and distribute copyrighted works such as “art” (e.g., Thomas Kincaid's painting “Dawn in Los Gatos”) and characters (e.g., Mickey Mouse). With such license, a licensee need not fear a claim-n of copyright infringement brought by the licensor. In some cases, a compulsory copyright license may be applicable. A compulsory copyright license is an exception to copyright law that is usually philosophically justified as an attempt by the government to correct a market failure. As an exception to copyright, another party can exercise one or more of the copyright's exclusive rights without having to obtain the copyright holder's permission, but will have to pay a licensing fee. Embodiments of the present invention assist in obtaining the appropriate legal authorization of media.

Referring back now to FIG. 5, after the user obtains a licensing agreement, the user reviews the licensing agreement parameters at step 520. If the user agrees with the parameters, the user enters into a licensing agreement for the media at step 525. If the user does not agree, the user may request a modification to the licensing agreement. It should be understood that the licensing agreement can apply to multiple media and is not limited the area of copyrights, but rather includes all property rights.

FIG. 6 is a flow diagram 600 of a user accessing a licensing interface for a website. After beginning, a user, using a computer, accesses a licensing interface to obtain a license at step 605. After accessing the licensing interface, the user (at step 610) searches for available license details for a media. At step 615, the user locates the available media license. Next, the user reaches a licensing agreement with the owner of the media at step 620. In some embodiments, the licensing agreement includes, but is not limited to, a licensing fee. At step 625, for example, the user distributes a license fee to the owner based on the licensing agreement. In this example, the user provides for two scenarios to pay for the license. In one scenario, the user pays the fee based on a membership obtained from the owner at 630. In the second scenario, the user pays the fee based on the media owner's property rights (e.g., fair market value or negotiated price). Each case provides the user with the legal authorization to use the media in the media presentation.

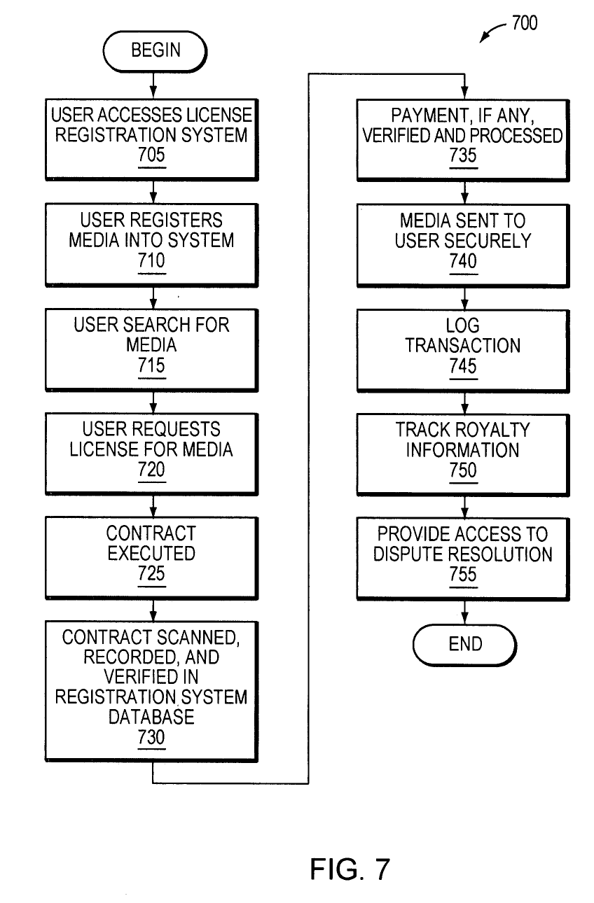

FIG. 7 is a flow diagram of an example process 700 for an overall process of executing and enforcing a licensing agreement. At step 705, a user accesses a license registration system. Next, the user registers the media into the system at step 710 and searches for the media at step 715. At step 720, the user request a license for the media and the user and media owner executes the licensing agreement contract at step 725. After the contract is executed, the license registration system scans, records, and verifies the contract at step 730. If applicable, the user makes a payment to the owner at step 735. Next, the user receives the media in a secure manner at step 740 and the transaction is logged at step 745. In some embodiments, the system tracks royalty information at step 750 and can also provide dispute resolution in step 755 for a dispute between the user and media owner. In this way, a license can be easily obtained for a user making a media production.

It should be understood that any of the processes disclosed herein, such as compiling media, creating a media presentation, accessing a licensing interfaces, executing and enforcing a licensing agreement, or the flow diagrams of FIGS. 4-7, may be implemented in the form of hardware, firmware, or software, If implemented in software, the software may be processor instructions in any suitable software language and stored on any form of computer readable medium. The processor instructions are loaded and executed by a processor, such as a general purpose or application specific processor, that, in turn, performs the example embodiments disclosed herein.

While this invention has been particularly shown and described with references to example embodiments thereof, it will be understood by those skilled in the art that various changes in form and details may be made therein without departing from the scope of the invention encompassed by the appended claims.

What is claimed is:

1. A method of data processing to compile a digital data media presentation for transferring between one or more computers comprising:
requesting one or more digital data media;
if applicable, obtaining authorization to use the one or more digital data media;
editing the requested digital data media and any existing digital data media in such a manner as to make a media presentation; and
compiling the one or more digital data media to produce a media presentation.

2. A method as is claimed in claim 1 further comprising the step of performing a search for one or more digital data media to use in the media presentation.

3. A method as is claimed in claim 1 further comprising the step of performing a search for the one or more digital data media in one or more network nodes.

4. A method as is claimed in claim 1 wherein the one or more digital data media is one of the following: film, movie, report, television, webisode, commercial, beta, or digital.

5. A method as is claimed in claim 1 further comprising the step of presenting a user with a display of one or more digital data media.

6. A method as is claimed in claim 1 wherein the step of requesting one or more digital data media further includes obtaining legal authorization for using the one or more digital data media.

7. The method of claim 6 wherein legal authorization includes one of the following: a license agreement, a copyright clearance, or compulsory license.

8. A method as is claimed in claim 1 wherein the step of editing further includes using a editor tool to modify the one or more media.

9. A method as is claimed in claim 1 wherein the step of editing further includes integrating the one or more media in such a way as to make a single media presentation.

10. A method as is claimed in claim 1 wherein the step of compiling further includes creating a useable product for a end user from the media presentation.

11. A method as is claimed in claim 1 wherein the step of compiling further includes creating a useable product for a end user from a excerpt of the media presentation.

12. A method as is claimed in claim 10 wherein the useable product is a CD, CDRW, DVD, HDVD, online sharing program, or other suitable presentation.

13. A computer to compile a media presentation to transfer between one or more computers comprising:
a network node to request one or more digital data media, where the request is authorized;
an editor configured to edit the requested media and any existing media in such a way to make a media presentation; and
a compiler configured to compile the one or more digital data media to produce a media presentation.

14. A computer as is claimed in claim 13 wherein a search module is configured to perform a user search for one or more digital data media to use in the media presentation.

15. A computer as is claimed in claim 13 wherein a search module is configured to perform a search for the one or more digital data media in one or more network nodes.

16. A computer as is claimed in claim 13 wherein the one or more digital data media is one of the following: film, movie, report, television, webisode, commercial, or beta.

17. A computer as is claimed in claim 13 where in the network node is further configured to present a user with a display of one or more digital data media.

18. A computer as is claimed in claim 13 wherein the network node is further configured to obtain legal authorization for using the one or more digital data media.

19. A computer as is claimed claim 18 wherein legal authorization is a license agreement, a copyright clearance, or compulsory license.

20. A computer as is claimed in claim 13 wherein the editor is further configured to modify the one or more digital data media using a digital tool.

21. A computer as is claimed in claim 13 wherein the editor is further configured to integrate multiple medias in such a way as to make a single media presentation.

22. A computer as is claimed in claim 13 wherein the compiler is further configured to create a useable product for an end user from the media presentation.

23. A computer as is claimed in claim 13 wherein the compiler is further configured to create a useable product for a end user from a excerpt of the media presentation.

24. A computer as is claimed in claim 22 wherein the useable product is a CD, CDRW, DVD, HDVD, online sharing program, or other suitable presentation.

25. A computer to compile a media presentation to transfer between one or more computers comprising:
means for requesting one or more digital data media;
means for obtaining authorization, if applicable, to use the one or more digital data media;
means for editing the requested digital data media and any existing digital data
means for media in such a manner as to make a media presentation; and
means for compiling the one or more digital data media to produce a media presentation.
